(19) United States
(12) Patent Application Publication
(10) Pub. No.: US 2002/0145519 A1
(43) Pub. Date: Oct. 10, 2002

(54) Roadside animal warning system

(76) Inventor: Harold Hykawy, Selkirk (CA)

Correspondence Address: ADE & COMPANY, 1700-360 MAIN STREET, WINNIPEG, MB, R3C3Z3, CA

(21) Appl. No.: 10/098,467

(22) Filed: Mar. 18, 2002

(30) Foreign Application Priority Data
Apr. 9, 2001 (CA) 2,343,493

(51) Int. Cl. G08B 13/18

(52) U.S. Cl. 340/567; 340/541; 340/573.1

(57) ABSTRACT

A roadside warning system is provided for detecting animals alongside a road. The system includes a plurality of infrared heat detection sensors arranged generate a heat signal in response to detection of a body of heat alongside the road. A warning light is illuminated in response to determination by a processor that the body of heat is an animal. A timer keeps the light illuminated for a prescribed period of time following detection of the body of heat in order to warn drivers of animals which have recently passed through the detection zone in addition to warning drivers of animals within the detection zone.

### FIELD OF THE INVENTION

The present invention relates to a system for detecting the presence of animals and more particularly to a warning system for warning persons on a road of animals alongside the road.

### BACKGROUND

A common problem occurring on roads in proximity to areas where animals, for example deer and the like, are known to frequent is the collision of vehicles on the road with the animals. In addition to the death of these animals, this problem causes significant injuries to vehicle occupants involved in such collisions as well as costly damage to vehicles and property.

U.S. Pat. No. 5,939,987 to Cram provides a roadside deer warning system which uses motion sensors along the side of a road to illuminate warning lights visible to vehicle occupants on the road when deer are detected alongside the road. The use of motion sensors however is often ineffective in areas where bushes and the like are found alongside the road as the deer may emerge suddenly from the bushes undetected by the motion sensors without warning. Furthermore, the system fails to warn drivers of animals which are at rest, grazing and the like, or of animals which have recently passed through the detection zone but are then located just outside of the range of the motion sensors.

### SUMMARY

According to one aspect of the present invention there is provided a roadside warning system for detecting animals alongside a road, the system comprising:

a plurality of sensors arranged to be supported alongside the road, each sensor comprising an infrared heat detection sensor arranged generate a heat signal in response to detection of a body of heat alongside the road;

a processor including a prescribed heat condition and being arranged to generate a warning signal representative of an animal in proximity to one of the sensors when the heat signal exceeds the prescribed heat condition; and

a warning light coupled to the processor and being arranged to be activated in response to receipt of the warning signal for warning persons on the road of the presence of the animal.

The use of infrared heat detection sensors arranged to detect a body of heat alongside the road ensures that the system remains active if animals within the designated field of detection are at rest or are hidden behind bushes and the like which would normally interfere with a motion sensor.

The processor may include a timer arranged to latch the warning signal for a prescribed length of time. The warning light would thus be arranged to remain activated until the prescribed length of time has expired. The processor and sensors preferably remain active during the prescribed period of time with the timer being arranged to restart upon generation of a second warning signal during the prescribed period of time. The timer keeps the light illuminated during the prescribed period of time following detection of the body of heat in order to warn drivers of animals which have recently passed through the designated detection zone in addition to warning drivers of animals within the detection zone.

The heat condition may comprise a heat magnitude threshold which must be exceeded in order to generate a warning signal. The processor would preferably be arranged to automatically adjust the heat magnitude threshold in response to varying ambient temperature.

When each sensor includes a prescribed field of detection within which a body of heat may be detected, the sensors are preferably mounted along the roadside with the respective fields of detection arranged in an overlapping configuration.

There may be provided a processor and a warning light associated with each of the sensors. Each light in this instance would preferably include a respective power supply. The power supply may comprise a battery and a solar panel arranged to recharge the battery.

Each sensor and the processor and warning light associated therewith are preferably all contained within a common housing. A battery may then be provided within the common housing providing power to the processor and light. A solar panel may additionally be arranged to recharge the battery wherein the solar panel comprises a frusto conical shaped member mounted above housing having an upwardly facing apex and being arranged to extend a full 360 degrees of rotation about the housing. The housing may further be insulated.

Each sensor may also include a lens having an anti-stick coating thereon. The lens deters the collection of dirt and precipitation thereon so as not to interfere with the field of detection of the sensor.

### BRIEF DESCRIPTION OF THE DRAWINGS

In the accompanying drawings, which illustrate an exemplary embodiment of the present invention:

FIG. 1 is a top plan view of a section of road having the roadside warning system installed thereon.

FIG. 2 is an isometric view of one of the sensor housings.

FIG. 3 is a schematic illustrating the operation of the sensors of the warning system.

### DETAILED DESCRIPTION

Referring to the accompanying drawings, there is illustrated a roadside deer warning system generally indicated by reference numeral 10. The system is intended to detect animals 12, including deer and the like, along side a road 14 for warning occupants of vehicles 16 on the road of the presence of animals.

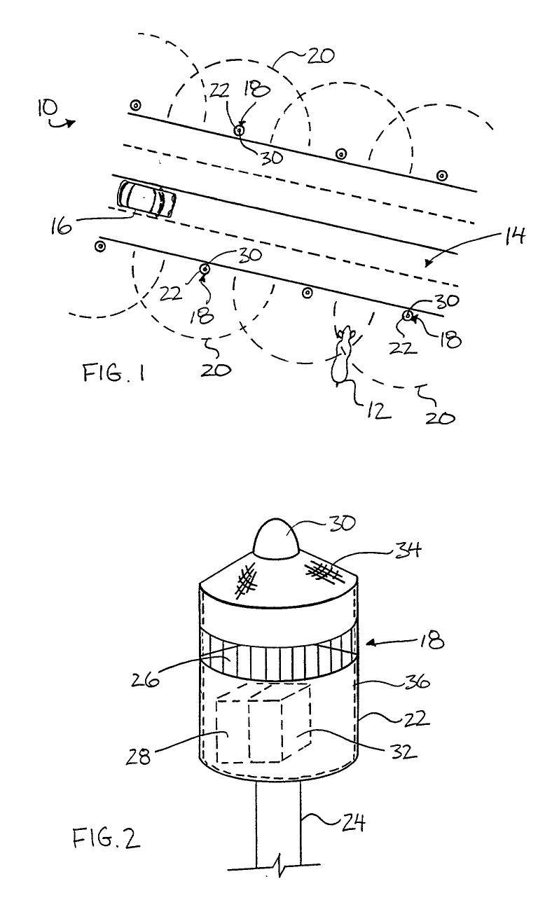

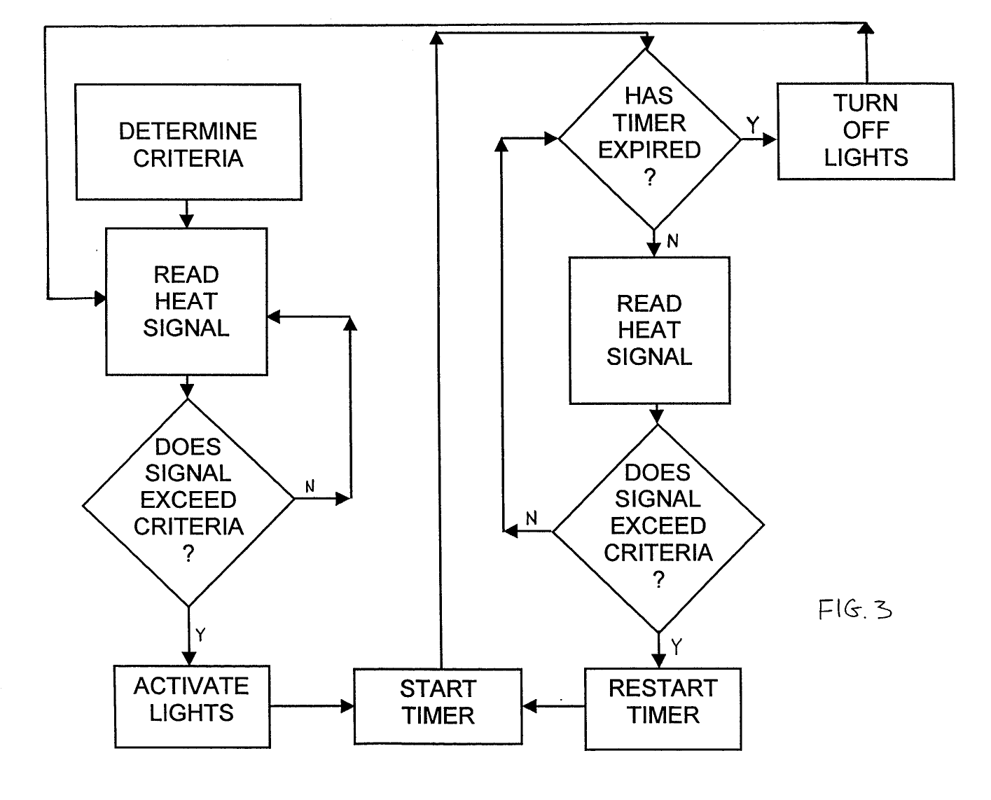

The system 10 includes a plurality of sensors 18 which are mounted at spaced positions along each side of the road 14. Each sensor 18 comprises an infrared heat detector which is arranged to detect the presence of a body of heat within a prescribed field of detection. The prescribed field of detection is generally semi-circular extending through 180 degrees about the sensor with the sensors being located adjacent the roadway such that the field of detection spans outwardly from the respective side of the roadway. The sensors 18 are positioned sufficiently close to one another so that the respective fields of detection 20 are arranged in an overlapping configuration as illustrated in FIG. 1.

Each sensor is enclosed within a rigid cylindrical housing 22 which is supported above the ground on a post 24 also formed of rigid material. The sensor is enclosed within the housing by a lens 26 which extends about the housing 22 through the 180° of the field of detection. The lens 26 includes a non-stick coating thereon, for example Teflon and the like, for deterring the collection of dirt and precipitation thereon.

A processor 28 is enclosed within the housing 22 which is arranged to determine the presence of an animal within the field of detection upon receipt of a heat signal generated by the sensor in response to detection of a body of heat within the field of detection. The processor compares the heat signal from the sensor to the established criteria of a prescribed heat condition to determine if a warning signal should be generated. The criteria of the prescribed heat condition include a heat magnitude threshold and a heat signal duration threshold, both of which must be exceeded in order for the presence of an animal within the respective field of detection to be determined. Once the presence of an animal has been determined the warning signal is generated by the processor.

The heat magnitude threshold is a threshold for which the magnitude of the heat signal must exceed while the duration threshold is a threshold of which the duration of the heat signal must exceed. Both thresholds are adjustable over a range of values upon initial installation to optimize performance of the system and minimize erroneous identification of the presence of animals. The magnitude threshold in particular is dependent upon the ambient temperature. The processor is arranged to sense the ambient temperature and automatically adjust the magnitude threshold because the heat signal detected by the sensors which is generated by an animal can vary seasonally in regions where the climate is known to vary between both hot and cold extremes.

A warning light 30 is mounted on each housing 22, centrally on a top side thereof. The warning light 30 is intended to be illuminated upon detection of a warning signal generated by the processor and is arranged to be sufficiently bright so as to be visible by approaching vehicle occupants.

The light 30 is powered by a battery 32 which is also enclosed within the housing 22. The battery is recharged by a solar panel 34 mounted on a top side of the housing 22. The solar panel 34 is a frusto conical shaped member having an upwardly pointing apex. The surface of the panel 34 thus extends 360° around the top of the cylindrical housing 22 with the light 30 being arranged to be secured on the apex 36 thereof. The surface of the solar panel 34 is thus inclined from horizontal so as to be optimally aligned with the sun for the greater part of each day. Arranging the surface of the panel to extend 360° about the housing also ensures that the panel is properly aligned with the sun regardless of the orientation of the housing.

Each sensor 18 and its associated processor 28 and battery 32 are all commonly enclosed within the respective housing 22 with the solar panel 34 and the light 30 secured thereabove in a compact and secure arrangement. Insulating material 36 is provided on the inner walls of the housing 22 so as to surround the electronic components, including the processor and battery, within the housing.

The processor 28 further includes a timer which is arranged to latch the warning signal for a prescribed period of time following initial activation of the light 30. The prescribed period of time of the timer starts when the light is initially activated and holds the light on for the duration of the prescribed period of time. The prescribed period of time is adjusted for any duration which is appropriate to detect animals which have just passed through the field of detection of one of the sensors but are likely still in proximity to the road or may even be on the road itself. The processor 28 and the associated sensor 18 remain active during the prescribed period of time so as to enable the processor to generate a second warning signal should the animal return to the field of detection or should another animal enter the field of detection during the prescribed period of time. When a second warning signal is generated the timer is restarted to prolong the duration for which the light remains activated. Once the timer has finally expired the light 30 is turned off while the processor 28 and associated sensor 18 continue scanning for further bodies of heat within the field of detection.

The operation of the processor 28 is illustrated schematically in FIG. 3. As illustrated the criteria of the prescribed heat conditions are first determined for optimal effectiveness of the system. Once activated the sensor 18 continuously generates heat signals in response to bodies of heat within the field of detection thereof which are subsequently read by the processor 28. If the heat signal exceeds the prescribed heat condition the light 30 is activated but if the signal does not exceed the prescribed heat condition the processor 28 continues to read another heat signal.

Once the light 30 has been activated the timer is started while the processor continues to read heat signals from the sensor, at each instance determining if the heat signal exceeds the prescribed heat condition. During the prescribed period of time the processor continuously checks whether the timer has either expired or been restarted due to the generation of a second warning signal by the processor. Once the timer has finally expired the light switches from an activated state to a deactivated state while the processor continues to read heat signals generated by the sensor.

While one embodiment of the present invention has been described in the foregoing, it is to be understood that other embodiments are possible within the scope of the invention. The invention is to be considered limited solely by the scope of the appended claims.

1. A roadside warning system for detecting animals alongside a road, the system comprising:
a plurality of sensors arranged to be supported alongside the road, each sensor comprising an infrared heat detection sensor arranged generate a heat signal in response to detection of a body of heat alongside the road;
a processor including a prescribed heat condition and being arranged to generate a warning signal representative of an animal in proximity to one of the sensors when the heat signal exceeds the prescribed heat condition; and
a warning light coupled to the processor and being arranged to be activated in response to receipt of the warning signal for warning persons on the road of the presence of the animal.

2. The roadside warning system according to claim 1 wherein the processor includes a timer arranged to latch the warning signal for a prescribed length of time, the warning light being arranged to remain activated until the prescribed length of time has expired.

3. The roadside warning system according to claim 2 wherein the processor and sensors remain active during the prescribed period of time, the timer being arranged to restart upon generation of a second warning signal during the prescribed period of time.

4. The roadside warning system according to claim 1 wherein the heat condition comprises a heat magnitude threshold which must be exceeded in order to generate a warning signal.

5. The roadside warning system according to claim 4 wherein the processor is arranged to automatically adjust the heat magnitude threshold in response to varying ambient temperature.

6. The roadside warning system according to claim I wherein each sensor includes a prescribed field of detection within which a body of heat may be detected, the sensors being mounted along the roadside with the respective fields of detection arranged in an overlapping configuration.

7. The roadside warning system according to claim 1 wherein there is provided a processor and a warning light associated with each of the sensors.

8. The roadside warning system according to claim 7 wherein each light includes a respective power supply.

9. The roadside warning system according to claim 8 wherein the power supply comprises a battery and a solar panel arranged to recharge the battery.

10. The roadside warning system according to claim 7 wherein each sensor and the processor and warning light associated therewith are all contained within a common housing.

11. The roadside warning system according to claim 10 wherein there is provided a battery within the common housing providing power to the processor and light and a solar panel arranged to recharge the battery, the solar panel comprising a frusto conical shaped member mounted above housing having an upwardly facing apex and being arranged to extend a full 360 degrees of rotation about the housing.

12. The roadside warning system according to claim 11 wherein the housing is insulated.

13. The roadside warning system according to claim 1 wherein each sensor includes a lens having an anti-stick coating thereon.
